(19) United States
(12) Patent Application Publication
(10) Pub. No.: US 2019/0185169 A1
(43) Pub. Date: Jun. 20, 2019

(54) UNMANNED AERIAL VEHICLE

(71) Applicant: SZ DJI TECHNOLOGY CO., LTD., Shenzhen (CN)

(72) Inventors: Bogao XU, Shenzhen (CN); Zhenzhou LAI, Shenzhen (CN); Lei WANG, Shenzhen (CN)

(21) Appl. No.: 16/283,358

(22) Filed: Feb. 22, 2019

Related U.S. Application Data
(63) Continuation of application No. PCT/CN2016/103712, filed on Oct. 28, 2016.

(30) Foreign Application Priority Data
Aug. 23, 2016 (CN) 201620922283.X

(51) Int. Cl. B64D 27/24; B64C 39/02; B64C 27/37; H01M 2/26; H01M 2/10

(52) U.S. Cl. CPC B64D 27/24; B64C 39/024; B64C 27/37; H01M 2220/20; H01M 2/1083; B64C 2201/027; B64C 2201/042; H01M 2/263

(57) ABSTRACT

An unmanned aerial vehicles (UAV) comprises an airframe, a battery mounted at the airframe, and a magnetic sensor mounted at the airframe. The battery comprises one or more multi-tab wound cells, the one or more the multi-tab wound cells comprise one or more electrode sheets and a plurality of tabs electrically connected to the one or more electrode sheets. An electrode sheet of the one or more electrode sheets is provided with one or more of the plurality of tabs. The magnetic sensor is spaced apart from the battery.

### CROSS-REFERENCE TO RELATED APPLICATIONS

This application is a continuation application of International Application No. PCT/CN2016/103712, filed on Oct. 28, 2016, which claims priority to Chinese Application No. 201620922283.X, filed on Aug. 23, 2016, the entire contents of both of which are incorporated herein by reference.

### TECHNICAL FIELD

The present disclosure relates to an unmanned aerial vehicles (UAV) and, more particularly, to a battery of the unmanned aerial vehicle.

### BACKGROUND

As technology advances, aerial photography technology is booming, among which drone aerial photography is gradually favored by photographers because of its lowered cost and enhanced safety as compared to manned aerial photography. The drone aerial photography is often carried out by using an aircraft equipped with an imaging device, such as a video camera, and a camera, etc. An UAV (i.e., drone) generally includes a fuselage, a plurality of arms mounted at the fuselage, and power apparatuses disposed at the arms. The power apparatuses as well as the electrical and electronic components on the UAV are typically powered by a power supply. Due to the needs of flight control, the UAV is often equipped with a compass. However, when supplying the power to the UAV, the power supply itself generates a magnetic field due to electromagnetic induction, and the compass may create errors or even malfunction due to the presence of the generated magnetic field.

To avoid or/and reduce the power-supply-caused magnetic disturbances to which the compass is subjected thereby ensuring the sensitivity of the compass, a method of increasing the distance between the power supply and the compass is often employed. However, as the distance between the power supply and the compass increases, the UAV is required to have a large volume accordingly, which is contrary to the current demand for miniaturization and weight reduction of the UAV. Moreover, an UAV having a large volume occupies a large space, which is not favorable for the storage and carry of the UAV.

### SUMMARY

In accordance with the disclosure, there is provided an unmanned aerial vehicles (UAV) comprising an airframe, a battery mounted at the airframe and a magnetic sensor mounted at the airframe. The battery comprises one or more multi-tab wound cells, the one or more the multi-tab wound cells comprise one or more electrode sheets and a plurality of tabs electrically connected to the one or more electrode sheets. An electrode sheet of the one or more electrode sheets is provided with one or more of the plurality of tabs. The magnetic sensor is spaced apart from the battery.

### BRIEF DESCRIPTION OF THE DRAWINGS

FIG. 1 is a perspective view of an unmanned aerial vehicle (UAV) according to an embodiment of the disclosure.

FIG. 2 is a perspective view of a folded state of the UAV in FIG. 1.

FIG. 3 is a perspective view of a battery cell of a battery of the UAV in FIG. 1.

FIG. 4 is a schematic view of a positive electrode sheet of the battery in FIG. 3.

FIG. 5 is a schematic view of a negative electrode sheet of the battery in FIG. 3.

FIG. 6 is a graph showing strength of magnetic disturbances experienced by a magnetic sensor when an UAV employs a conventional wound battery.

FIG. 7 is a graph showing strength of magnetic disturbances experienced by a magnetic sensor when an UAV employs a conventional wound battery and a multi-tab wound battery, respectively.

Description of main components and reference numerals

| | |
|---|---|
| Unmanned aerial vehicle (UAV) | 100 |
| Airframe | 10 |
| Fuselage | 12 |
| Battery compartment | 121 |
| Arm | 14 |
| Power apparatus | 30 |
| Motor | 32 |
| Propeller | 34 |
| Battery cell | 50 |
| Positive electrode sheet | 52 |
| Positive tab | 521 |
| Negative electrode sheet | 54 |
| Negative tab | 541 |

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “mounted” at a second component, it is intended that the first component may be directly mounted at the second component or may be indirectly mounted at the second component via a third component between them. When a first component is referred to as “connecting/connected” to a second component, it is intended that the first component may be directly connecting/connected to the second component or may be indirectly connecting/connected to the second component via a third component between them. When a first component is referred to as “arranged” at a second component, it is intended that the first component may be directly arranged at the second component or may be indirectly arranged at the second component via a third component between them.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

The inventors have found that the flight control of an UAV often depends on the sensing data provided by the compass. The sensitivity of the compass is affected by not only the natural magnetic field but also the magnetic field generated by the electronic and electrical components of the UAV. A compass at a large UAV is less interfered than a compass at a small UAV, and such a phenomenon (i.e., compasses at aircrafts of different sizes are subjected to different degrees of magnetic disturbances) is related to not only the volume of the UAV but also the relative positive of the battery and the compass of the UVA. Thus, the inventors have improved the relative position of the battery and the compass in the present disclosure.

Further, based on the current miniaturization and lightweight design requirements of UAVs, the inventors focused on designs of increasing the sensitivity of the compass at small UAVs. However, due to the limited capacity/volume of the airframe of small UAVs, the design freedom for reducing the magnetic disturbances experienced by the compass via increasing the distance between the compass and the electrical and electronic components, or via providing an electromagnetic shielding member is rather limited. The inventors have found that to avoid or/or significantly reduce the magnetic disturbances experienced by the compass, design/improvement of the electronic and electrical components themselves is highly desired. Thus, the inventors have made significant improvements in this respect in the present disclosure.

In view of the above, the present disclosure provides a small UAV in which the sensitivity of the compass is enhanced. The UAV may include an airframe, a battery, and a compass. The battery may be mounted at the airframe and include one or more multi-tab wound cells, and the multi-tab wound cell may include one or more electrode sheets and a plurality of tabs electrically coupled to the one or more electrode sheets. Each electrode sheet may be provided with one or more of the plurality of tabs. The compass may be mounted at the airframe and spaced apart from the battery by a gap.

The above-mentioned compass is only one type of magnetic sensors, which is for illustrative purposes and is not intended to limit the scope of the present disclosure. The solution provided by the present discourse can also be applied to any appropriate types of magnetic sensors, such as a magnetic field sensor, and a magnetic position sensor, etc.

Exemplary embodiments will be described with reference to the accompanying drawings. In the situation where the technical solutions described in the embodiments are not conflicting, they can be combined.

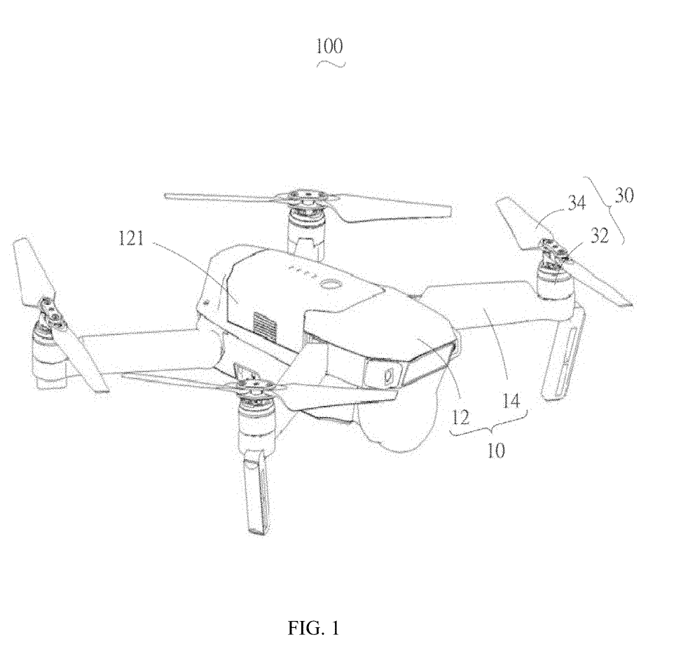

FIG. 1 is a perspective view of an unmanned aerial vehicle (UAV) according to an embodiment of the disclosure. As shown in FIG. 1, the UAV is illustrated by taking a rotor UAV 100 as an example.

The UAV 100 may include an airframe 10 and one or more power apparatuses 30 disposed at the airframe 10. The power apparatus 30 may provide the UAV 100 with flight power. In one embodiment, the power apparatus 30 may be a rotor assembly and the UAV 100 may be a multi-rotor aircraft. For illustrative purposes, FIG. 1 shows a four-rotor aircraft as an example. Each rotor assembly may include a motor 32 disposed at the airframe 10 and a propeller 34 disposed at the motor 32.

The motor 32 may drive the propeller 34 to rotate, thereby providing flight power to the UAV 100. The propeller 34 may be a foldable propeller. When the rotor assembly is in a non-operating state, the blades of the propeller 34 may be folded and gathered to be in a folded state with respect to the motor 32. The motor 32 may also drive the blades of the propeller 34 to rotate, thereby enabling the blades to rotate relative to the motor 32 to be unfolded from the folded state.

In the disclosed embodiments, the airframe 10 may include a fuselage 12 and a plurality of arms 14 disposed at the fuselage 12, and the power apparatus 30 may be disposed at the arm 14. In one embodiment, the UAV 100 may be a foldable UAV, and each of the arms 14 may be movably coupled to the fuselage 12.

In one embodiment, as shown in FIG. 1, the arm 14 may be rotatably coupled to the fuselage 12. When the UAV 100 is in an operation state (i.e., in flight), the four arms 14 may be configured surrounding the fuselage 12, where the four arms 14 are in an unfolded state relative to the fuselage 12 and extending in a direction away from the fuselage 12.

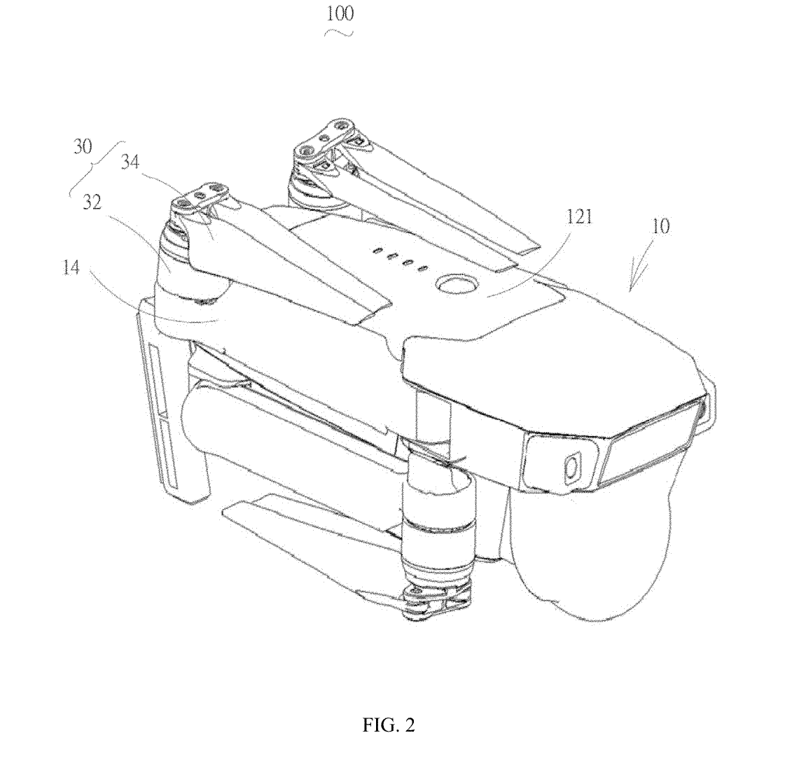

FIG. 2 is a perspective view of a folded state of the UAV in FIG. 1. Referring to FIG. 2 and FIG. 1, when the UAV 100 is in the non-operation state (i.e., not in flight), the four arms 14 may be respectively rotated relative to the fuselage 12 and gathered around the fuselage 12, where the space occupied by the arm 14 and the power apparatus 30 thereon may be small. Thus, when in the non-operating state (not in flight), the UAV 100 in which the arms 14 are folded and gathered around the fuselage 12 may occupy a small space, which is favorable for storage and carry of the UAV.

In the disclosed embodiments, the UAV 100 may have a relatively small size/volume, and/or have a relatively light weight. In other words, the UAV 100 may be a lightweight and/or small UAV. In particular, when the UAV 100 is in flight (i.e., unfolded state, as shown in FIG. 1), the arm 14 may be in an unfolded state with respect to the airframe 12, and a gap or spacing between the power apparatuses 30 arranged at a diagonal of the UAV 100 may be greater than or equal to about 10 cm, 12 cm, 15 cm, 20 cm, 25 cm, 30 cm, 35 cm, 40 cm, 45 cm, 50 cm, or 60 cm, etc. Alternatively, the spacing between the power apparatuses 30 arranged at the diagonal of the UAV 100 in flight may fall within a numeric range determined by any two of the above values.

When the UAV 100 is not in flight (i.e., folded state, as show in FIG. 2), the arm 14 may be folded and gathered with respect to the fuselage 12, and a gap or spacing between the power apparatuses 30 arranged at a diagonal of the UAV 100 may be greater than or equal to about 5 cm, 8 cm, 10 cm, 12 cm, 15 cm, 20 cm, 25 cm 30 cm, 35 cm, or 40 cm, etc. Alternatively, the spacing between the power apparatuses 30 arranged at the diagonal of the UAV 100 in the non-flight state may fall within a numeric range determined by any two of the above values.

In certain embodiments, the UAV 100 may be a small UAV instead of a foldable aircraft. The length of the fuselage 12 of the UAV 100 may be smaller than or equal to about 10 cm, 12 cm, 15 cm, 20 cm, 25 cm, 30 cm, 35 cm, 40 cm, 45 cm, or 50 cm, etc. Alternatively, the length of the fuselage 12 of the UAV 100 may fall within a numeric range determined by any two of the above values.

The UAV 100 may be a lightweight UAV. In particular, the UAV 100 may have a weight greater than or equal to about 100 grams, 200 grams, 300 grams, 400 grams, 500 grams, 600 grams, 700 grams, 800 grams, 900 grams, 1000 grams, 1300 grams, 1500 grams, 1800 grams, or 2000 grams, etc. Alternatively, the weight of the UAV 100 may fall within a numeric range determined by any two of the above values.

Further, the UAV 100 further may include a battery and a compass. In one embodiment, the battery may be a lithium battery. The battery may supply power to the electrical and electronic components on the UAV 100, such as supplying power to the power apparatus 30. In addition, the battery may be electrically connected to the compass and supply power to the compass. In one embodiment, the battery may be mounted at the fuselage 12 of the UAV 100. In particular, the fuselage 12 may be provided with a battery compartment 121 for housing the battery. Further, the battery compartment 121 may be approximately located at a central position (i.e., the center) of the fuselage 12, and the battery may be detachably housed in the battery compartment 121.

Further, the UAV 100 may further include a stand (not shown) for supporting the UAV 100 when it is landed. In one embodiment, the stand may be disposed at the airframe 10 and coupled to the fuselage 12. In another embodiment, the stand may be coupled to the arm 14. In another embodiment, the stand may be coupled to the fuselage 12 and the arm 14 at the same time. The battery may be mounted at the stand.

In another embodiment, the battery may be mounted at other parts of the airframe 10, for example, the battery may be mounted at the arm 14, or mounted at the stand of the UAV 100. Further, the battery may be mounted at any appropriate position on the UAV 100 and electrically connected to the electrical and electronic components.

The compass may sense the orientation of the UAV 100 to facilitate the control of the UAV 100 by a flight controller. In one embodiment, the number of the compasses may be two, and the two compasses may be disposed at the airframe 10 and spaced apart from each other to improve the control precision of the flight controller. In particular, the two compasses may be respectively mounted at the nose and the tail of the fuselage 12. In another embodiments, the number of the compasses may be one or more, such as one, three, four, or even more.

When the UAV 100 includes a plurality of compasses, the plurality of compasses may be respectively mounted at different portions of the airframe 10. For example, the compass may be mounted at the fuselage 12, the arm 14, or the stand (not drawn) of the UAV 100. Further, the compass may be mounted at any appropriate location on the UAV 100. In the disclosed embodiments, the compass may be installed in the fuselage 12 and disposed adjacent to the battery, and a predetermined spacing may be configured between the compass and the battery.

In particular, the predetermined spacing between the compass and the battery may be less than or equal to about 35 cm, 30 cm, 25 cm, 20 cm, 15 cm, 10 cm, or 5 cm, etc. Alternatively, the predetermined spacing between the compass and the battery may fall within a numerical range determined by any two of the above values. In certain embodiments, the compass and the battery may be in close contact with each other, for example, the compass may be disposed at the upper, bottom, side, etc. of the battery.

In the disclosed embodiments, the compass may be disposed relatively close to the battery, such that the internal space of the fuselage 12 may be utilized more efficiently, and the volume of the UAV 100 may be limited to a small range, which may facilitate the lightweight and miniaturized design of the UAV 100. Further, a preset distance may be configured between the compass and the battery, and the preset distance may fall within the predetermined spacing, thereby ensuring that the volume of the UAV 100 is limited to a small range. In particular, the preset distance may be greater than or equal to about 1 mm, 3 mm, 5 mm, 8 mm, 1 cm, 3 cm, 5 cm, 8 cm, or 10 cm, etc. Alternatively, the preset distance may fall within a numerical range determined by any two of the above values.

In certain embodiments, the compass may be disposed relatively far away from the battery. For example, the battery may be mounted at one end of the fuselage 12, and the compass may be mounted at another end of the fuselage 12. Alternatively, the battery may be mounted at the fuselage 12, and the compass may be mounted at the stand of the UAV 100.

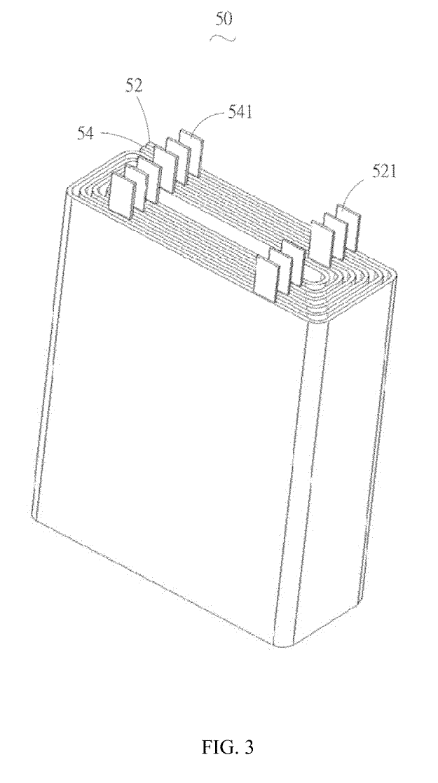

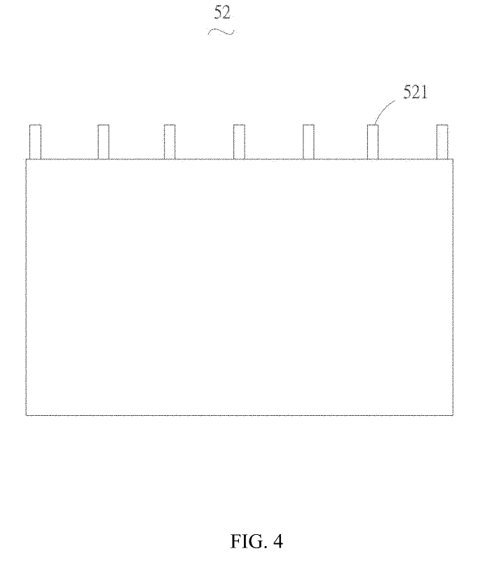

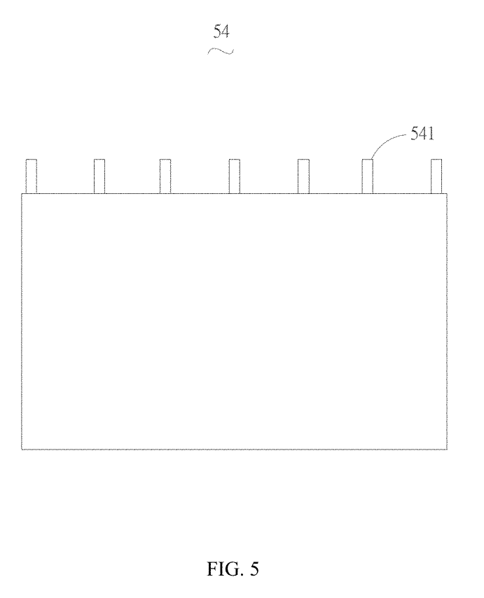

FIG. 3 is a perspective view of a battery cell of a battery of the UAV in FIG. 1. FIG. 4 is a schematic view of a positive electrode sheet of the battery in FIG. 3. FIG. 5 is a schematic view of a negative electrode sheet of the battery in FIG. 3. Referring to FIG. 3 to FIG. 5, the battery may be a multi-tab wound battery, which may include a battery cell 50. The battery cell 50 may include one or more multi-tab wound battery cells. The multi-tab wound battery cell may include one or more electrode sheets and a plurality of tabs electrically connected to the electrode sheets. Each electrode sheet may be provided with one or more of the plurality of tabs.

In one embodiment, as shown in FIG. 3 to FIG. 5, the one or more electrode sheets may include a positive electrode sheet 52, a negative electrode sheet 54, and a separator (not drawn). The positive electrode sheet 52 and the negative electrode sheet 54 may be separated by the separator, and winding to form the multi-tab wound battery cell. A plurality of positive tabs 521 may be disposed at the positive electrode sheet 52, and a plurality of negative tabs 541 may be disposed at the negative electrode sheet 54.

Further, in one embodiment, the multi-tab wound battery cell and the compass may be configured without any electromagnetic shielding members disclosed therebetween, such that the design of the relative position of the battery and the compass may be more flexible. The rational use of the internal space of the UAV 100 may be facilitated, and the structure among the components of the UAV 100 may be more compact, thereby facilitating the miniaturization design of the UAV 100.

In another embodiment, an electromagnetic shielding member (not drawn) may be disposed between the multi-tab wound battery cell and the compass, thereby further reducing the magnetic disturbances caused by the battery in operation on the compass and ensuring the sensitivity of the compass.

When the UAV 100 is a small UAV in which the battery and the compass are disposed at the fuselage 12, it is often difficult to reserve enough spacing between a conventional battery and the compass to reduce the magnetic disturbances caused by the battery on the compass. However, the inventors have found that when the battery is a multi-tab wound battery, the magnetic disturbances caused by the battery on the compass may be significantly reduced magnetic disturbances.

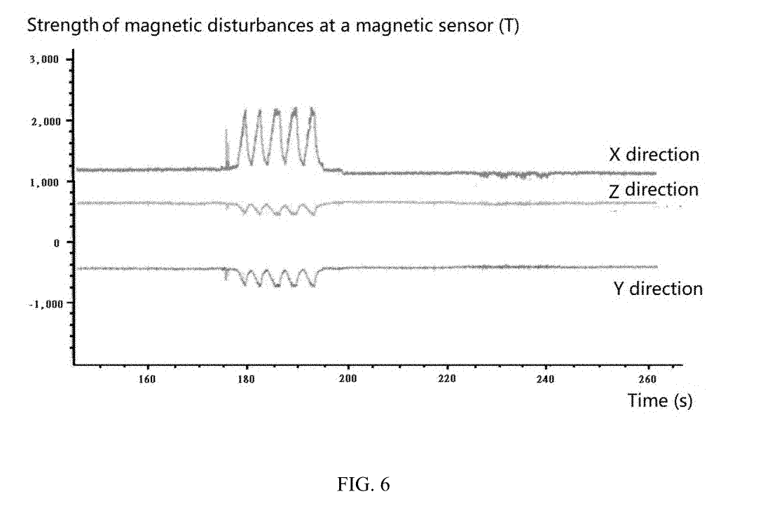

FIG. 6 is a graph showing strength of magnetic disturbances experienced by a magnetic sensor when the UAV 100 employs a conventional wound battery. As shown in FIG. 6, the horizontal axis represents the time, and the vertical axis represents the strength of magnetic disturbances at the compass. In particular, the distance between the conventional wound battery and the compass increases with time. When the time is about 180 seconds, the conventional wound battery may be arranged as close as possible to the compass, i.e., the conventional wound battery and the compass may be simultaneously disposed inside the fuselage 12, and the strength of magnetic disturbances may exhibit a maximum value in X, Y, Z directions. When the time is about 240 seconds, the conventional wound battery and the compass may be installed inside and outside the fuselage 12, respectively. That is, the compass may be disposed inside the fuselage 12, and the battery may be disposed outside the fuselage 12, or vice versa. The X, Y, Z directions are the three coordinate axes of the three-dimensional Cartesian coordinate system. In the disclosed embodiments, the X, Y, Z directions correspond to the axis of pitch, the axis of roll, and the axis of yaw of the UAV 100, respectively.

As FIG. 6 shows, the smaller the distance between the conventional wound battery and the compass, the greater the magnetic disturbances experienced by the compass. When the distance between the conventional wound battery and the compass approaches the limit, the compass may be greatly disturbed, the degree of the magnetic disturbances may have been severe enough to affect the flight control of the UAV 100, and the UAV 100 may be even not functioning properly.

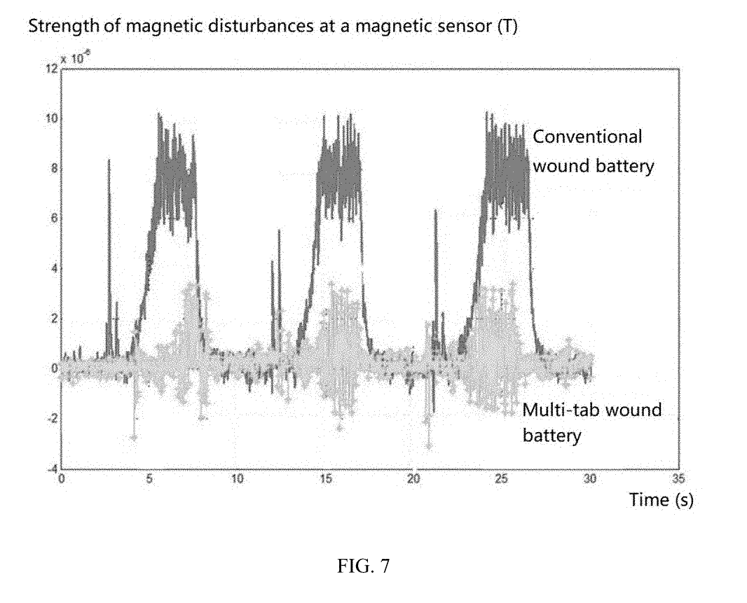

FIG. 7 is a graph showing strength of magnetic disturbances experienced by a magnetic sensor when the UAV 100 employs a conventional wound battery and a multi-tab wound battery, respectively. As shown in FIG. 7, the horizontal axis represents the time and the vertical axis represents the strength of magnetic disturbances at the compass. In particular, the distance between the conventional wound battery and the compass periodically changes with the time. When the UAV 100 respectively employs a conventional wound battery and a multi-tab wound battery, the distance between the conventional wound battery and the compass and the distance between the multi-tab wound battery and the compass may change over time in a same rate.

As shown in FIG. 7, given a same distance between the battery and the compass, the multi-tab wound battery may exert significantly reduced magnetic disturbances on the compass as compared to the conventional wound battery. When the distance between the multi-tab wound battery and the compass is significantly reduced (e.g., when the distance is reduced to be equal to or smaller than 100 mm), the strength of magnetic disturbances experienced by the compass may change slightly, the strength of magnetic disturbances experienced by the compass may be within the allowable range, and the UAV 100 may fly normally. When the distance between the conventional wound battery and the compass is significantly reduced (e.g., when the distance is reduced to be equal to or smaller than 100 mm), the strength of magnetic disturbances experienced by the compass may be significantly increased. When the distance between the conventional wound battery and the compass reaches about 50 mm, the strength of magnetic disturbances experienced by the compass may exceed the limit, and the UAV 100 may not fly normally.

In the disclosed embodiments, the UAV 100 may employ a multi-tab wound battery as a power supply. During the operation of the multi-tab wound battery, a ring current may be not formed inside the multi-tab wound battery and, thus, the generated magnetic field may exert a relatively small disturbances on the compass. Even when the distance between the multi-tab wound battery and the compass is small, or even the multi-tab wound battery and the compass are in contact with each other without any electromagnetic shielding member disposed therebetween, the magnetic disturbances caused by the multi-tab wound battery on the compass during the operation of the multi-tab wound battery may be still small, which may not affect the normal operation of the compass. Accordingly, the normal operation of the UAV 100 may be ensured.

In summary, the multi-tab wound battery employed by the UAV 100 may be disposed close to the compass, through which the sensing sensitivity of the compass may be ensured while the space of the airframe of the UAV 100 may be reasonably utilized. Thus, the volume of the UAV 100 may be limited to a small range, which may facilitate the miniaturization and lightweight design of the UAV 100. In addition, the multi-tab wound battery may have a relatively large capacity and a low cost and, thus, may be suitable for mass-scale production, which may reduce the production cost of the UAV 100 to a certain extent.

For illustrative purposes, the magnetic sensor in the disclosed embodiments is described by taking a compass as an example. The compass is only one type of magnetic sensor, and the solution provided by the present discourse can also be applied to other types of magnetic sensors, such as a magnetic field sensor, a magnetic position sensor, etc.

It can be understood that, in certain embodiments, the UAV 100 may be provided with a plurality of batteries, and one or more of the plurality of batteries may be the multi-tab wound battery described above, and the other of the plurality of batteries may be a battery other than the multi-tab wound battery, such as a stacked battery, a single-tab wound battery, etc. The stacked battery and the single-tab wound battery may be disposed far away from the compass, while the battery having the multi-pole wound battery cells may be disposed adjacent to the compass according to actual needs, such that the compass may be prevented from being affected by the magnetic disturbances caused by the stacked battery and the single-tab wound battery. In certain other embodiments, the plurality of batteries may all be batteries having multi-tab wound battery cells.

It is intended that the embodiments be considered as exemplary only and not to limit the scope of the disclosure. Those skilled in the art will be appreciated that any modification or equivalents to the disclosed embodiments are intended to be encompassed within the scope of the present disclosure.

What is claimed is:

1. An unmanned aerial vehicles (UAV) comprising:
an airframe;
a battery mounted at the airframe and comprising one or more multi-tab wound cells, wherein the one or more the multi-tab wound cells comprise one or more electrode sheets and a plurality of tabs electrically connected to the one or more electrode sheets, and an electrode sheet of the one or more electrode sheets is provided with one or more of the plurality of tabs; and
a magnetic sensor mounted at the airframe and spaced apart from the battery.

2. The UAV of claim 1, wherein:
the airframe comprises a fuselage and a plurality of arms connected to the fuselage, wherein the battery is disposed at the fuselage.

3. The UAV of claim 2, wherein:
the arms are movably coupled to the fuselage; and
the arms are movable relative to the fuselage to be in a folded state or an unfolded state.

4. The UAV of claim 3, wherein:
the magnetic sensor is mounted at at least one of the fuselage or the arms.

5. The UAV of claim 3, wherein:
the airframe further comprises a stand connected to at least one of the fuselage or the arms, wherein the magnetic sensor is mounted at the stand.

6. The UAV of claim 3, further comprising:
power apparatuses disposed at the arms and providing the UAV with flight power.

7. The UAV of claim 6, wherein:
when the arms are in the unfolded state, a spacing between the power apparatuses arranged at a diagonal of the UAV is smaller than or equal to 60 cm.

8. The UAV of claim 6, wherein:
when the arms are in the folded state, a spacing between the power apparatuses arranged at a diagonal of the UAV is smaller than or equal to 30 cm.

9. The UAV of claim 2,
wherein the magnetic sensor is a first magnetic sensor;
the UAV further comprising:
a second magnetic sensor, the first magnetic sensor and the second magnetic sensor being mounted at different portions of the fuselage.

10. The UAV of claim 9, wherein:
the first magnetic sensor and the second magnetic sensor are mounted at a nose and a tail of the fuselage, respectively.

11. The UAV of claim 2, wherein:
the fuselage is disposed with a battery compartment; and
the battery is detachably housed in the battery compartment.

12. The UAV of claim 11, wherein:
the battery compartment is arranged at a center of the fuselage.

13. The UAV of claim 2, wherein:
the fuselage has a length smaller than or equal to 40 cm.

14. The UAV of claim 1, wherein:
a distance between the magnetic sensor and the battery is smaller than or equal to 30 cm.

15. The UAV of claim 1, wherein:
the magnetic sensor is disposed at the battery; and/or
an electromagnetic shielding member is disposed between the one or more multi-tab wound battery cells and the magnetic sensor.

16. The UAV of claim 1, wherein:
the one or more electrode sheets include a positive electrode sheet, a negative electrode sheet, and a separator disposed between the positive electrode sheet and the negative electrode sheet; and/or.
the magnetic sensor includes at least one of a compass, a magnetic field sensor, or a magnetic position sensor.

17. The UAV of claim 1, wherein:
the UAV is foldable;
the battery includes a lithium battery; and/or
the battery provides a power to the magnetic sensor.

18. The UAV of claim 1, wherein:
the UAV has a weight smaller than or equal to 1000 grams.
